(19) United States
(12) Patent Application Publication
(10) Pub. No.: US 2025/0376261 A1
(43) Pub. Date: Dec. 11, 2025

(54) ENVIRONMENTAL CONTROL SYSTEM OF AN AIRCRAFT CONFIGURED WITH A TWO-PHASE TURBINE ENCASED WITH A COMPRESSOR AND MOTOR

(71) Applicant: Hamilton Sundstrand Corporation, Charlotte, NC (US)

(72) Inventor: Viktor Kilchyk, Lancaster, NY (US)

(21) Appl. No.: 18/735,592

(22) Filed: Jun. 6, 2024

(51) Int. Cl. B64D 13/08; B64D 13/06

(52) U.S. Cl. CPC B64D 13/08; B64D 2013/0648

(57) ABSTRACT

An environmental control system of an aircraft, having: a cooling circuit including: a sealed housing; a turbo-compressor sealed within the housing, wherein the turbo-compressor includes: a compressor fluidly coupled to the circuit; a turbine fluidly coupled to the circuit downstream of the compressor, wherein the turbine is a flash turbine; a shaft operably coupling the compressor and the turbine; and a motor generator operably coupled to the turbo-compressor and disposed within the housing.

### BACKGROUND

The embodiments are directed to an environmental control system (ECS) of an aircraft and more specifically to an ECS of an aircraft configured with a two-phase turbine that is encased with a compressor and motor.

An ECS that utilizes a two-phase vapor cycle system (VCS) may be unable to capture and utilize waste heat. This may result in a loss in thermodynamic performance. Efforts to capture and utilize such waste heat may be expensive and heavy, due to the utilization of special purpose equipment such as extra heat exchangers, compressors, pumps, turbines, ducting, valves, controllers, etc. This may result in a reduction in aircraft space utilization and fuel efficiency.

### BRIEF DESCRIPTION

Disclosed is an environmental control system of an aircraft, including: a cooling circuit including: a sealed housing; a turbo-compressor sealed within the housing, wherein the turbo-compressor includes: a compressor fluidly coupled to the circuit; a turbine fluidly coupled to the circuit downstream of the compressor, wherein the turbine is a flash turbine; a shaft operably coupling the compressor and the turbine; and a motor generator operably coupled to the turbo-compressor and disposed within the housing.

In addition to one or more aspects of the system or as an alternate, the housing includes ports to fluidly couple the compressor and the turbine with the cooling circuit.

In addition to one or more aspects of the system or as an alternate, the motor generator is coupled to the shaft, between the compressor and the turbine.

In addition to one or more aspects of the system or as an alternate, the system includes a compressor-side outboard shaft coupled to the compressor, and the motor generator is coupled the compressor-side outboard shaft.

In addition to one or more aspects of the system or as an alternate, the system includes a turbine-side outboard shaft coupled to the turbine, and the motor generator is coupled the turbine-side outboard shaft.

In addition to one or more aspects of the system or as an alternate, the cooling circuit further includes an evaporator and a condenser.

In addition to one or more aspects of the system or as an alternate, the condenser is a RAM air condenser.

In addition to one or more aspects of the system or as an alternate, the system includes a splitter; and a mixer, wherein: a first branch of the cooling circuit extends between an inlet of the splitter and an outlet of the mixer; and wherein: the first branch includes the evaporator, the compressor and the condenser; or the first branch includes the compressor and the condenser, and the evaporator is disposed on a vapor-liquid branch circuit.

In addition to one or more aspects of the system or as an alternate, a second branch of the cooling circuit extends between a first outlet of the splitter and a first inlet of the mixer; and the second branch includes the turbine and a control valve between the turbine and the splitter.

In addition to one or more aspects of the system or as an alternate, a third branch of the cooling circuit extends between a second outlet of the splitter and a second inlet of the mixer; and the third branch includes an expansion valve.

### BRIEF DESCRIPTION OF THE DRAWINGS

The following descriptions should not be considered limiting in any way. With reference to the accompanying drawings, like elements are numbered alike:

FIG. 1A shows an environmental control system of an aircraft configured with a two-phase turbine that is encased with a compressor and motor;

FIG. 1B shows an embodiment of the two-phase turbine that is encased with the compressor and motor, where the motor is between the turbine and the compressor;

FIG. 1C shows an embodiment of the two-phase turbine that is encased with the compressor and motor, where the motor is outboard of the compressor; and

FIG. 1D shows an embodiment of the two-phase turbine that is encased with the compressor and motor, where the motor is outboard of the turbine; and

FIG. 2 shows another embodiment of the system shown in FIG. 1A, where an evaporator of the system is in a vapor-fluid branch circuit.

### DETAILED DESCRIPTION

A detailed description of one or more embodiments of the disclosed apparatus are presented herein by way of exemplification and not limitation with reference to the Figures.

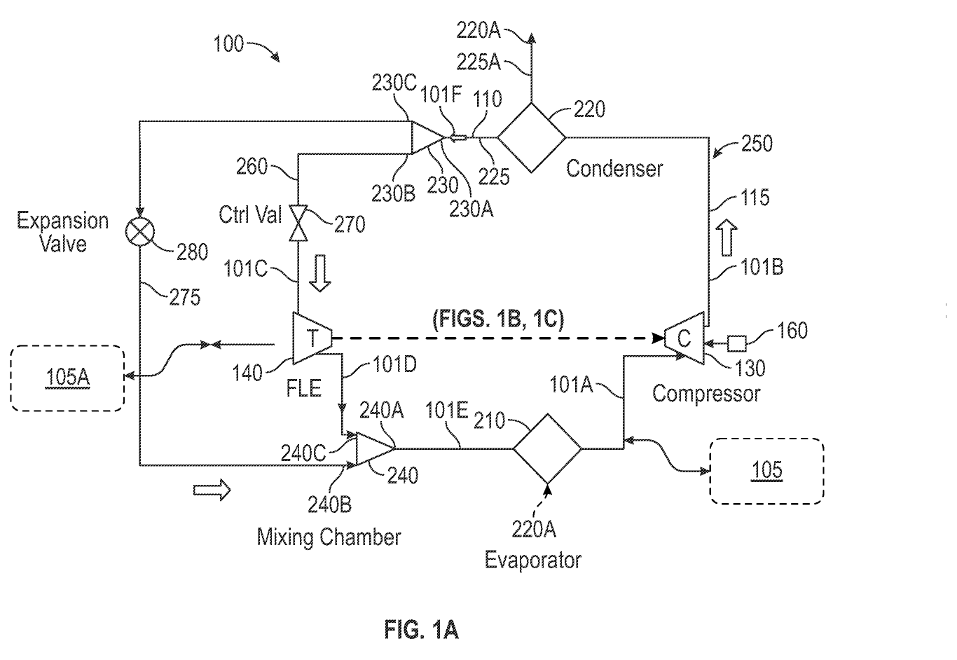

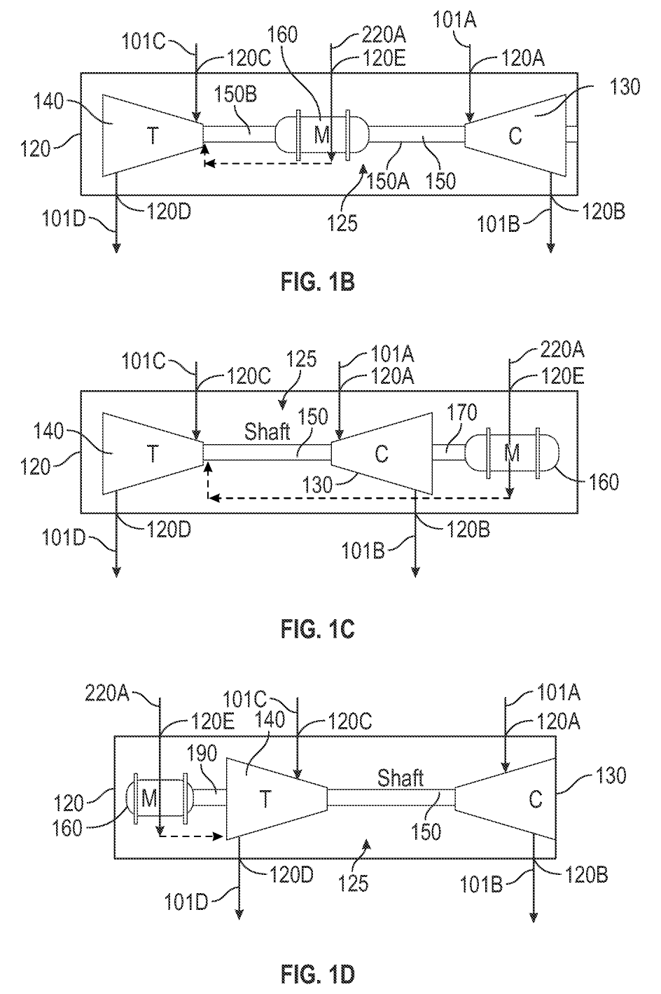

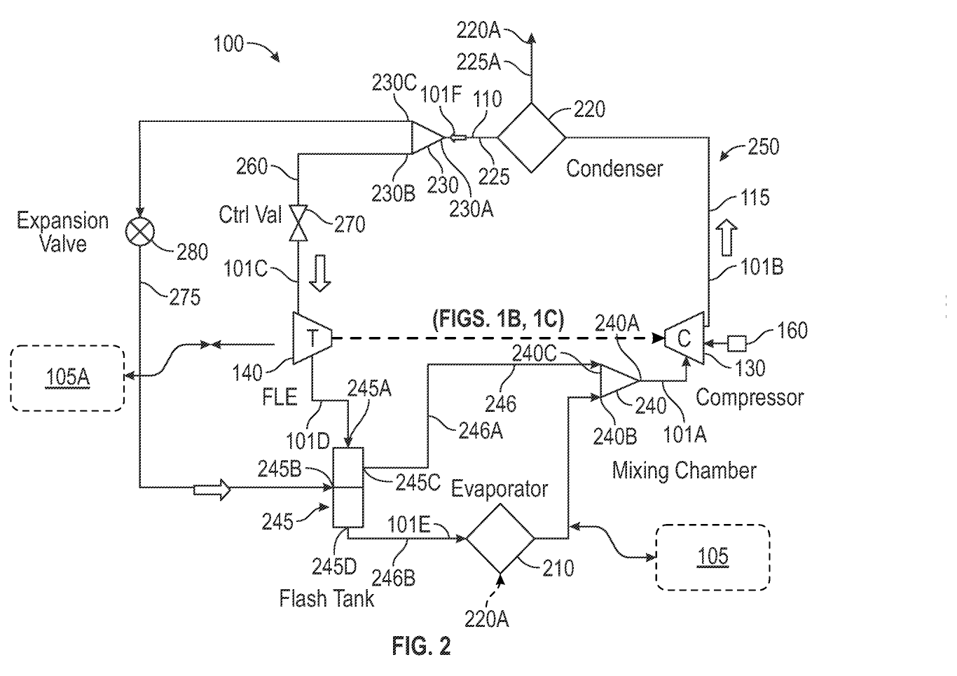

Turning to FIG. 1A, an environmental control system (ECS) 100 of an aircraft 105 is shown, where the aircraft 105 is depicted schematically. The ECS 100 includes a cooling circuit 110 through which a working fluid 115 flows. The cooling circuit 110 includes a sealed housing 120, shown in different embodiments in FIGS. 1B-1D. Having components of the refrigerant cycle within the sealed housing 120 may reduce the requirement to provide containment seals for such components as would normally otherwise be required.

As shown in FIGS. 1B-1D, a turbo-compressor 125 is sealed within the housing 120. The turbo-compressor 125 includes a compressor 130 fluidly coupled to the circuit 110. A first conduit 101A of the circuit 110 extends through a first port 120A in the housing 120 to transport the working fluid 115 to the compressor 130. A second conduit 101B of the circuit 110 extends through a second port 120B in the housing 120 to transport the working fluid 115 away from the compressor 130.

The turbo-compressor 125 includes a turbine 140 sealed within the housing 120. The turbine 140 is fluidly coupled to the circuit 110 downstream of the compressor 130 (FIG. 1A). A third conduit 101C of the circuit 110 extends through a third port 120C in the housing 120 to transport the working fluid 115 to the turbine 140. A fourth conduit 101D of the circuit 110 extends through a fourth port 120D in the housing 120 to transport the working fluid 115 away from the turbine 140. The turbine 140 is a flash turbine, so that it is capable of extracting energy from a two phase flow. In operation, the turbine 140 may be utilized to generate electricity to power an aircraft system 105A, shown schematically. It can be appreciated that the housing 120 includes the ports 120A-120D, and other ports disclosed herein, to fluidly couple the compressor and turbine with the cooling circuit 110 (FIG. 1A).

A shaft 150 operably couples the compressor 130 and the turbine 140. A motor generator 160 is operably coupled to the turbo-compressor 125 and is disposed within the housing 120.

As shown in FIG. 1B, in one embodiment the motor generator 160 is coupled to the shaft 150, between the compressor 130 and the turbine 140. In this configuration, the shaft 150 may be configured as two shaft portions 150A, 150B, where one of the shaft portions 150A extends from the compressor 130 to the motor generator 160 and another one of the shaft portions 150B extends from the turbine 140 to the motor generator 160. As shown in FIG. 1C a compressor-side outboard shaft 170 is coupled to the compressor 130. The motor generator 160 is coupled the compressor-side outboard shaft 170. As shown in FIG. 1D, a turbine-side outboard shaft 190 is coupled to the turbine 140. The motor generator 160 is coupled the turbine-side outboard shaft 170.

Turning back to FIG. 1A, the cooling circuit 110 further includes an evaporator 210 that is upstream of the compressor 130 and delivers the working fluid 115 to the compressor 130. A fifth conduit 101E transports the working fluid 115 to the evaporator 210 and the first conduit 101A transports the working fluid 115 from the evaporator 210 to the compressor 130.

A condenser 220, which may be a RAM air condenser, is downstream of the compressor 130 and receives the working fluid 115 from the compressor 130. The second conduit 101B transports the working fluid 115 to the evaporator 210 from the compressor 130 and a sixth conduit 110F transports the working fluid 115 in the form of a condensed liquid flow (or condensed liquid, for simplicity) 225 downstream from the condenser 220 along the circuit 110.

A portion of the condensed liquid 225A may be directed to the motor generator 160 for cooling purposes. A condenser conduit 220A may extend from the condenser 220 to the motor generator 160, through a fifth port 120E in the housing 120 to deliver the condensed liquid 225A (FIGS. 1B-1D). Condensed liquid 225 that has absorbed waste heat from the motor generator 160 may be directed, e.g., to the turbine 140 within the housing 120 to enable greater energy extraction by the turbine 140. Alternatively, it may be directed to the evaporator 210 via the condenser conduit 220A.

The circuit 110 includes a splitter 230 and a mixer 240. A first branch 250 of the cooling circuit 110 extends between an inlet 230A of the splitter 230 and an outlet 240A of the mixer 240. The first branch 250 includes the evaporator 210, the compressor 130 and the condenser 220 along with the conduits, generally 101, that transport the working fluid 115 to and from each of these components. For example, the fifth conduit 101E extends from the output of the mixer 240 to the evaporator 210 and the sixth conduit 101F extends from the condenser 220 to the inlet 230A of the splitter 230.

A second branch 260 of the cooling circuit 110 extends between a first outlet 230B of the splitter 230 and a first inlet 240B of the mixer 240. The second branch 260 includes the turbine 140 and a control valve 270 between the turbine 140 and the splitter 230, and includes the third conduit 101C into the turbine 140 from the control valve 270 and fourth conduit 101D out of the turbine 140 toward the first inlet 240B of the mixing valve 240. A third branch 275 of the cooling circuit 110 extends between a second outlet 230C of the splitter 230 and a second inlet 240C of the mixer 240. The third branch 275 includes an expansion valve 280. It can be appreciated that the control valve 270 is open when running the system 100 in a mode (or first mode) to generate power from the turbine 140, e.g. to power the aircraft system 105A. The control valve 270 may be closed to operate the system 100 in a mode (or second mode) to primarily to control atmospheric conditions on the aircraft 105.

Turing to FIG. 2, an alternate configuration to the system of FIG. 1A is shown, which utilizes the turbo-compressor 125 of FIGS. 1B-1C. That is, the environmental control system (ECS) 100 of an aircraft 105 is shown, where the aircraft 105 is depicted schematically. The ECS 100 is a vapor refrigeration system that includes a cooling circuit 110 through which a working fluid 115 flows.

The circuit 110 includes the mixing chamber 240 having an outlet 240A and first and second inlets 240B, 240C. The circuit 110 includes the splitter 230 having the inlet 230A and first and second outlets 230B, 230C. The first branch 250 of the circuit 110 extends between the mixing chamber 240 and the splitter 230 and includes the compressor 130 and condenser 220, which may be coupled to the turbo-compressor 125 of FIGS. 1B-1C as indicated above via condenser conduit 220A. The first conduit 101A connects the outlet 240A of the mixing chamber with the compressor 130. The second conduit 101B connects the compressor 130 and the condenser 220.

The circuit 110 further includes a flash tank 245 having first and second inlets 245A, 245B, a first outlet 245C for vapor flow and a second outlet 245D for fluid flow. The second branch 260 of the circuit 110 extends from the first outlet 230B of the splitter 230 to the first inlet 245A of the flash tank 245. The second branch 260 includes the control valve 270 and the turbine 140. The third conduit 101C extends into the turbine 140 from the control valve 270 and the fourth conduit 101D extends out of the turbine 140 and to the first inlet 245A of the flash tank 245. The third branch 275 of the circuit 110 extends from the second outlet 230C of the splitter 230 to the second inlet 245B of the flash tank 245 and includes the expansion valve 280.

The cooling circuit 110 further includes a liquid-vapor branch circuit 246. A vapor branch 246A of the branch circuit 246 extends from the first outlet 245C of the flash tank 245 to the first inlet 240C of the mixing chamber 240. A liquid branch 246B of the branch circuit 246 extends from the second outlet 245D of he flash tank 245 to the second inlet 240B of the mixing chamber 240 and includes the evaporator 210, which may be coupled to the turbo-compressor 125 of FIGS. 1B-1C as indicated above via condenser conduit 220A.

Operation of the embodiment of FIG. 2 is essentially the same as in FIG. 1A except that the liquid-vapor branch circuit 246 allows for a single phase flow to the evaporator 210. This may increase the efficiency of the evaporator 210 and thus the system 100.

The disclosed embodiments utilize an ECS having a turbo-compressor configured with a flashing two-phase turbine 140. When the turbine 140 drives the compressor and generates electricity, a thermodynamic performance of an aircraft 105 may significantly increase. The housing 120 encloses the turbine 140, motor 160 and compressor 130, which may reduce the requirement to provide for containment seals normally required for aircraft refrigeration cycles.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An environmental control system of an aircraft, comprising:
a cooling circuit including:
a sealed housing;
a turbo-compressor sealed within the housing, wherein the turbo-compressor includes:
a compressor fluidly coupled to the circuit;
a turbine fluidly coupled to the circuit downstream of the compressor, wherein the turbine is a flash turbine;
a shaft operably coupling the compressor and the turbine; and
a motor generator operably coupled to the turbo-compressor and disposed within the housing.

2. The system of claim 1, wherein the housing includes ports to fluidly couple the compressor and the turbine with the cooling circuit.

3. The system of claim 1, wherein the motor generator is coupled to the shaft, between the compressor and the turbine.

4. The system of claim 1, further comprising a compressor-side outboard shaft coupled to the compressor, and the motor generator is coupled the compressor-side outboard shaft.

5. The system of claim 1, further comprising a turbine-side outboard shaft coupled to the turbine, and the motor generator is coupled the turbine-side outboard shaft.

6. The system of claim 1, wherein the cooling circuit further includes an evaporator and a condenser.

7. The system of claim 6, wherein the condenser is a RAM air condenser.

8. The system of claim 6, further including:
a splitter; and
a mixer,
wherein:
a first branch of the cooling circuit extends between an inlet of the splitter and an outlet of the mixer; and
wherein:
the first branch includes the evaporator, the compressor and the condenser; or
the first branch includes the compressor and the condenser, and the evaporator is disposed on a vapor-liquid branch circuit.

9. The system of claim 8, wherein:
a second branch of the cooling circuit extends between a first outlet of the splitter and a first inlet of the mixer; and
the second branch includes the turbine and a control valve between the turbine and the splitter.

10. The system of claim 9, wherein:
a third branch of the cooling circuit extends between a second outlet of the splitter and a second inlet of the mixer; and
the third branch includes an expansion valve.
